(19) United States
(12) Patent Application Publication
(10) Pub. No.: US 2003/0211443 A1
(43) Pub. Date: Nov. 13, 2003

(54) Dental device used for the placement of bases or liners and method thereof

(76) Inventor: James Magee III, Tallahassee, FL (US)

Correspondence Address: Carnes, Cona & Dixon, Innovation Park, 1673 West Paul Dirac Drive, Tallahasse, FL, 32310-3763, US

(21) Appl. No.: 10/141,190

(22) Filed: May 9, 2002

(51) Int. Cl. A61C 3/08; A61C 3/00

(52) U.S. Cl. 433/164; 433/141

(57) ABSTRACT

A dental device and process ideally suited for use with a tooth which may required bases or liners during the preparation of the tooth that is to receive restoration is disclosed. The device comprises a shank, which acts as a handle, and a tip. The tip is specifically designed for a particular location on tooth. This will provide for a set of tools, wherein each tip is configured for maximizing placement of the dycal either on the pulpal floor of a small or large cavity or on the axial wall of the tooth. For placement on the pulpal floor of a small cavity the tip includes a flat hexagonal shape; for placement on the pulpal floor of a large cavity, the tip includes a plunger shape; and for placement on the axial wall of the tooth, the tip includes a flat golf-club shape. Each tip can be fabricated from or coated with titanium nitride.

### BACKGROUND OF THE INVENTION

1. Field of the Invention

The present invention relates generally to a novel and unique dental device used for a tooth that may require bases or liners during the preparation of the particular tooth which is to receive restorations, and more particularly, to a dental device having a unique and novel structure and to the process of utilizing the dental device which adequately and efficiently delivers the base or liner to the surface of the particular prepared tooth, inherently reducing time and eliminating any waste of material generally associated with conventional placement of bases or liners.

2. Description of the Prior Art

During conventional tooth restoration, exposure of nerve endings can result. This exposure in the particular tooth can result in great discomfort and be particularly sensitive to various temperatures, such as varying degrees in heat and cold. To prevent or eliminate this discomfort, a conventional base or conventional liner is applied to the prepared tooth surface. In essence, this base or liner is placed between the dentin and the restoration to provide pulpal protection. Using a base or liner will prevent irritation of the nerve ending while aiding in the insulation and reformation of the tooth structure.

Commonly, dentists use a conventional dycal instrument to place the base or liner over the prepared tooth surface. A conventional dycal instrument is shown in FIG. 1. As seen, this conventional cavity liner placement instrument 1 includes a shank 2, which acts as the handle, and a tip 3. The shank is substantially short and for those who have average sized hands to large hands find this instrument difficult to manipulate. In addition, the tip includes a small round end 4. It is this end that will deliver the liner and/or base to the prepared surface. Unfortunately, this tip tends to be small and thus does not provide a sufficiently sized surface area for enabling an adequate amount of material to be carried to the desired surface.

Another shortcoming occurs in the process of transferring the liner from the typical dycal instrument to the prepared tooth surface. Generally, some amount of the base or liner material remains adhered on the tip of the instrument and thus provides for an inadequate amount of coverage. In addition, the remaining material becomes obstructive and does not allow for a smooth coverage to occur on the particular surface. This failure to provide a smooth placement innately provides a device and method, which does not efficiently enable accurate placement and thus provides a device that, defeats the intended purpose of the particular tool.

As can be seen, wasted time occurs when the liner is not evenly distributed along the floor or wall of the prepared tooth resulting in the material hardening before complete placement is achieved. Once the material is hardened it can no longer be utilized in the procedure and must be disposed of, thereby resulting in wasted product and an inefficient use of time.

It is evidenced in the prior art that many new and useful improvements to dental tools have been made to address a particular dental problem. For example, U.S. Pat. No. 5,098,292 issued to Lazarof discloses a dental instrument for use in filling cavities in teeth using a light activated filling compound. As the compound is packed and shaped within the cavity a light source is used to enable controlled activation of the activator in the filling compound.

Yet another example is seen in U.S. Pat. No. 4,521,191 issued to Ehrnford wherein disclosed is a provision for reducing discoloration and providing for durable function of condensing dental instruments used for placement of dental composite resin restorative materials.

U.S. Pat. No. 4,060,897 issued to Greenstein discloses a method of using a dental tool for forming dental restorations partially comprised of synthetic restoration material, as well as the method for making the tool.

None of these previous efforts, however, provide the benefits intended with the present invention or method. The present invention provides a product that is directly marketable to the consumer. Additionally, prior techniques do not suggest the present inventive combination of component elements as disclosed and claimed herein.

Accordingly, it is seen that there is a need for a dental tool instrument designed and configured to alleviate the waste of time and material during the application of the base or liner material. This instrument should be structured so as to spread the base or liner in an even manner providing the user complete control of the product.

Thus, as will be seen, the present invention achieves its intended purposes, objectives and advantages over the prior art device by accomplishing the needs and objectives as identified herein, through a new, useful and unobvious combination of component elements, which is simple to use, with the utilization of a minimum number of functioning parts, at a reasonable cost to manufacture, assemble, test and by employing only readily available materials.

### SUMMARY OF THE INVENTION

The present invention is a novel and unique dental device and process ideally suited for use with a tooth which may require bases or liners during the preparation of the tooth that is to receive restorations. During the restoration process, nerve endings may become exposed and thus provide for the tooth to be susceptible to discomfort and/or irritation, such as in the presence of heat or cold. The use of the bases and liners will prevent irritation of nerve endings of the tooth when placed thereon.

In the preferred embodiment, the dental device of the present invention comprises an elongated shank having a first end, known as the distal end, and a second end, known as the proximal end. Secured to the first end is a tip having an octagonal shaped tip. This tip is ideally suited for placing dycal on the pulpal floor of smaller cavities.

Another embodiment for the tip includes the shape and structure of a conventional golf club. This tip is ideally suited for placing dycal on the axial wall. Still a further embodiment for the tip includes a plunger shape, which is used for placing the dycal on the pulpal floor of larger cavities.

Each tip, as defined above, can be fabricated from a medical grade material, or preferably, is fabricated from or plated with titanium nitride.

Optionally, in an alternative embodiment of the dental device of the present invention, the first end and/or second end can include a connecting device. A plurality of tips is removably secured to the first end and/or second end. Each tip includes a corresponding attaching device that is enagageable to the connecting device of the elongated shank. Preferably, the connecting device comprises a threaded socket for threadably receiving a tip.

The elongated shank used in the various embodiments is designed and configured to be comfortably grasped by the fingers of the user. As such, the shank can have a roughened surface for enabling the user to have a firmer grip of the device of the present invention. Optionally, the shank can further include indentations or the like. These indentations are designed and configured to receive the thumb and index finger, innately providing a comfortable fit.

Normally in a dental restoration procedure of a tooth a typical dycal instrument is used to place the base or liner over the prepared tooth surface. During the transfer of the base or liner from the typical dycal instrument to the prepared tooth surface, the base or liner material adheres to the typical dycal instrument thereby substantially hindering the proper application of the base or liner to the tooth surface. By adhering to the instrument, a significant loss of time occurs since the dentist may experience difficulty in applying an even distribution of the base or liner material to the floor or wall of the tooth being prepared for restoration. Another disadvantage in the prior method is that by adhering to the instrument, an inadequate amount of coverage for the base or liner is not achieved, and thus, the dentist must quickly reapply before the base or liner hardens. If hardening does occur, then the excess base or liner that is located the prepared surface is discarded and more material is prepared and reapplied, consequently resulting in additional waste of time and material.

Using and operating the present invention is simple, easy, and extremely efficient. Ultimately providing a device that delivers the base or liner at least three times as fast as the conventional dycal instrument. To utilize the present invention, a sufficient amount of liner or base is placed on the tip of the device. The user then delivers the product to the prepared surface. Due to the shape of the tip as well as the material used for the tip, adhesion between the tip and the base or liner does not occur, thus substantially decreasing the time generally associated with applying a base or liner to a prepared surface. In addition to the prevention of adhesion between the tool and base or liner, this device of the present invention allows for the substance to be spread quickly and evenly on the tooth. Intrinsically providing the user with complete control of the substance, and thus resulting successful placement, efficient distribution, and substantially no waste of material.

Accordingly, it is the object of the present invention to provide for a dental device, which will overcome the deficiencies, shortcomings, and drawbacks of prior dental devices and methods thereof.

A further object of the present invention is to provide a dental device which is light weight and simple in design so as to provide for a dental device which can provide for a more efficient and effective process for tooth restoration.

Yet another object of the present invention is to provide for a novel and unique dental device which can provide interchangeable titanium nitride dental device tips for use in tooth restoration.

Still a further object of the present invention, to be specifically enumerated herein, is to provide a dental device in accordance with the preceding objects and which will conform to conventional forms of manufacture, be of simple design and easy to use so as to provide a dental device that would be economically feasible, long lasting and relatively trouble free in operation.

Although there have been many inventions related to dental devices, particularly those which are designed to address a particular dental problem, none of the inventions have become sufficiently compact, versatile, low cost, and reliable enough to become commonly used. The present invention meets the requirements of the simplified design, compact size, low initial cost, low operating cost and ease of maintainability.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWING

FIG. 1 is a side elevational view of a conventional cavity liner placement instrument.

FIG. 2a is a side elevation view of a first embodiment of the dental device, of the present invention, for use with dental restorations.

FIG. 2b is an enlarged front planar view of the tip used in the first embodiment of the present invention, as seen in FIG. 2a.

FIG. 3 is a side elevation view of an alternative dental device of the present invention having an altered tip and shank.

FIG. 4a is side elevation view of an alternative dental device of the present invention having an altered tip and shank.

FIG. 4b is an enlarged partial cross-section view of the tip illustrated in FIG. 4a.

FIG. 5 is an exploded side view of an alternative configuration of the dental device of the present invention being capable of accepting a plurality of tips removably secured thereto.

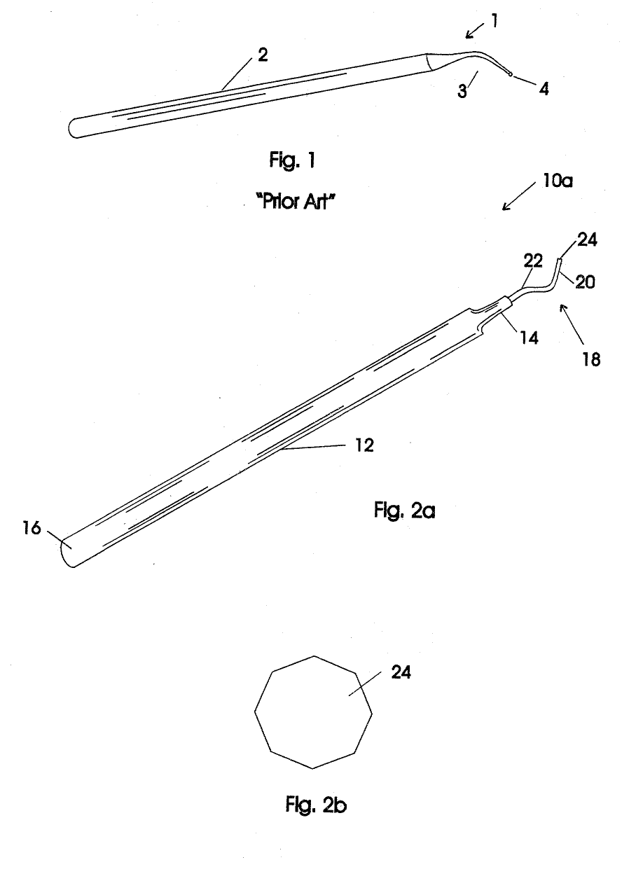

Similar reference numerals refer to similar parts throughout the several views of the drawings.

### DESCRIPTION OF THE PREFERRED EMBODIMENT

As seen in the drawings, in particular to FIGS. 2a-5 thereof, the present invention, a novel and unique dental device for tooth restorations, denoted by reference numeral 10 will be described herein. Shown is a dental device, ideally suited for tooth restorations, and optionally can be used interchangeably with other dental tools, or the like, and enables the dentist to efficiently and quickly deliver the base or liner to the tooth restoration at least three times as fast as the typical dycal instrument presently being used with no wasting of restoration material.

The first embodiment of the dental device 10a of the present invention is seen in FIG. 2. As seen in this figure, the dental device 10a comprising an elongated shank 12 having a first end or distal end 14 and a second end or proximal end 16. The shank 12 acts as a handle, thus providing for the user to manipulate and control the dental tool by utilizing this shank 12. Located and secured to the distal end 14 is a first tip 18. For increasing perceptibility, this distal end 14 as seen can be tapered. It is at this tapered point that the tip 18 is secured thereto.

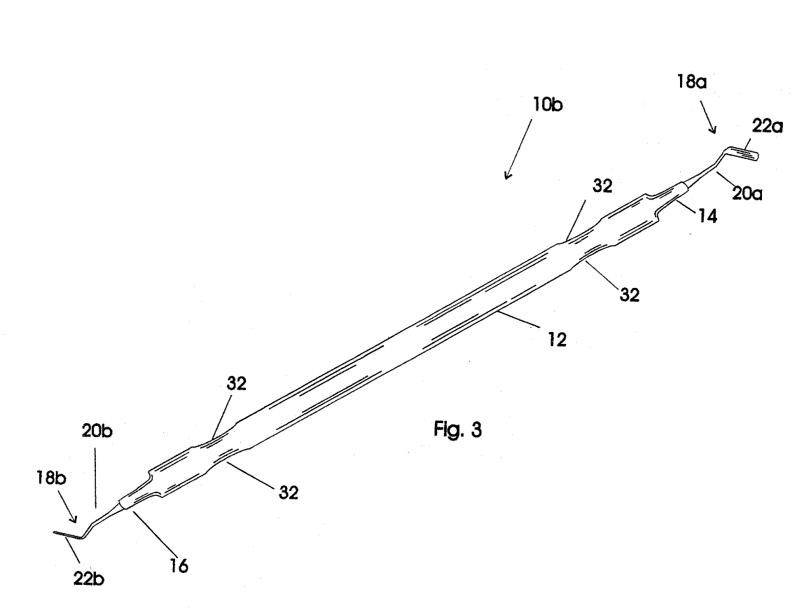

As seen in FIG. 2, this tip includes an upper portion 20 and a lower portion 22. The upper portion 20 is secured to the lower portion at an universal angle so as to enhance visibility and accessibility of the tooth, which is being restored. The tip illustrated in FIGS. 2 and 3 is ideally suited for placing dycal on the pulpal floor on smaller cavities. As such, the upper portion 20 of the tip includes an apex 24 in the shape of a flat octagonal shape (see FIG. 3). This flat shaped apex will enable an adequate amount of base or liner material to be placed thereon for transportation to the desired prepared surface. The use of an octagonal shape flat tip provides an ideal amount of surface area for accepting the material of the base or liner. In addition, the increase area, compared to the conventional ball shaped tip, will allow for a successful coating the first try and thus, innately provide for the first attempt to be adequate and triumphant.

Optionally, for utilizing the dental device of the present invention for placing dycal on the axial wall of the tooth, an alternative embodiment of the tool 10b, illustrated in FIG. 3 is shown. As seen, this tool includes a shank 12 having a first end or distal end 14 and a second end or proximal end 16. Secured to each end is a tip 18a and 18b, respectively.

Each tip includes an upper portion 20a and 20b, respectively, and a lower portion 22a and 22b. The upper portion 20 is secured to the lower portion at an universal angle so as to enhance visibility and accessibility of the tooth that is being restored.

The upper portion of each tip is secured to the at an opposite position. As seen in FIG. 3, the first portion 20a of the first tip 18a is secured to handle so that it extends upwardly with respect to the horizontal of the shank 12. The second portion 20b of the second tip 18b is secured to the handle so that it extends downwardly with respect to the horizontal of the shank. Hence, when the shank is horizontal to the plane, the first portion of the first tip will extend upwardly while the first portion of the second tip extends downwardly.

Structurally, the second portion 22a and 22b of each tip is identical in shape. This shape being a substantially flat golf-shape segment. Each segment is secured to its respective section differently. As seen in FIG. 3, the second portion 22a of the first end 14 is perpendicularly secured to the first portion 20a. This will provide for an L-shape configuration, wherein the widest area of the lower member of the L-shape is exposed. As seen, the flat golf-shape segment is clearly visible when the shank 12 is held in a horizontal position. The second portion 22b of the second end 16 is rotated approximately 90 degrees and then perpendicularly secured to the first portion 20a. This will provide for the edge of the flat golf-shape segment to be visible when the shank is held in the horizontal position. The use of the two positioned tips increases the usability of the tool of the present invention. Such a device will enable the user accessibility of the tool without sacrificing visibility.

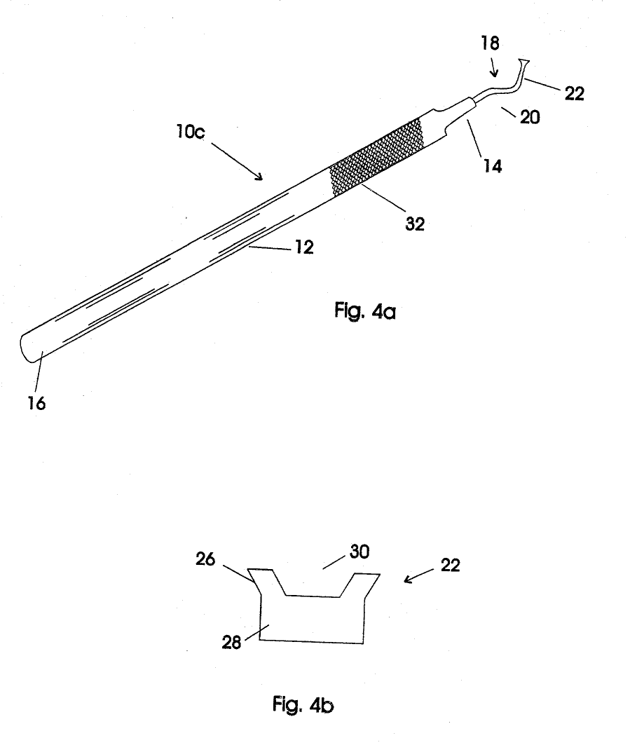

For placing dycal on the pulpal floor of larger cavities, a tip having the capacity for maintaining a significant amount of base or liner must be utilized. This tip is illustrated in FIGS. 4a and 4b. As seen, this tool 10c includes a shank 12 having a first end or distal end 14 and a second end or proximal end 16. Secured to the first end is a tip 18. The tip, like the tips of the first and second embodiment, include a first portion 20 secured angularly to the second portion 22. This angular attachment is universal.

The second portion includes an apex having a unique design and configuration. As seen in the figures, this apex has an upper area 26 larger in diameter than the lower area 28. Extending through the upper area is a groove 30. This groove will receive the base or liner.

In the preferred embodiments, the tips are fabricated from or coated with Titanium Nitride. This will provide for the tips to be non-toxic, durable, resistive to acids, bases, solvents, caustic, and the like, so as to provide for a dental tool that can be used in any type of dental procedure. In addition, titanium nitride produces a nonstick surface, making it an ideal substrate when distributing bases or liners.

The shank or handle of the tool of the present invention can be an elongated shaft as shown in FIG. 2a, but can also include a section that is roughened 32, as seen in FIG. 4a. This roughen surface will provide a more secure means of gripping and maintaining the shank of the present invention. Alternatively, as seen in FIG. 3, indentations 34 or the like, can be provided for the thumb and/or index finger. The use of indention 34 will provide a more comfortable fit for the user and thus increase the control when using the device. Other features for enhancing the produce, is to provide for the shank to be fabricated or coated with a soft cushioning substance, so as to allow for the user to have a comfortable grip when utilizing the tool of the present invention.

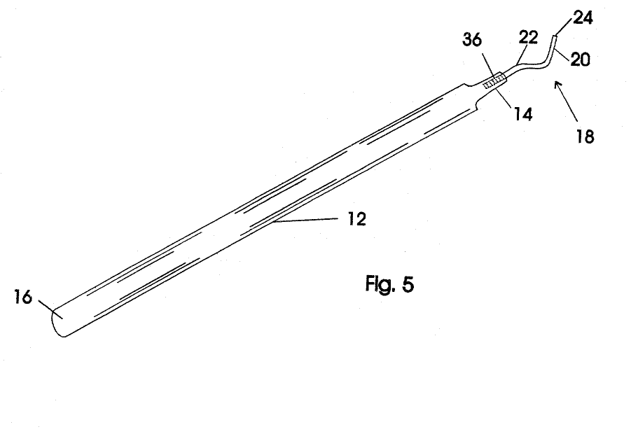

To add to the versatility of the tool device of the present invention, the tips can be designed to be removably secured to respective end. This removable securement can occur via conventional means, but in the preferred embodiment, and as illustrated in FIG. 5, the distal end 14 will include a hollow internally threaded bore 36. Each tip will include a shaft that is externally threaded. This will provide for the tips to be threadably secured to the particular end.

As seen in FIGS. 2a and 4a, the tool device can include a singular tip secured to an end, or optionally, as seen in FIG. 3, can have a tip secured to each end. The tips can be identical, yet disposed at different angles with respect to the horizontal of the shaft. Optionally, the tips can be different. Further still, each end can include attaching means so as to provide for the tips to be removably secured to each end, if desired.

While the invention has been particularly shown and described with reference to an embodiment thereof, it will be understood by those skilled in the art that various changes in form and detail may be made without departing from the spirit and scope of the invention.

I claim:

1. A dental device comprising:
a shank having a first end and a second end;
said shank acts as a handle;
a tip is located at said first end;
said tip includes an upper portion and a lower portion;
said upper portion is secured to said lower portion at an universal angle; and
said tip is fabricated from titanium nitride or is coated with titanium nitride.

2. A dental device as in claim 5 wherein said tip is removably secured to said shank.

3. A dental device as in claim 1 wherein said lower portion includes an apex and said apex is flat and includes a flat octagonal shape.

4. A dental device as in claim 1 wherein said lower portion includes an apex, said apex includes an upper area and a lower area, extending through said upper area is a groove.

5. A dental device as in claim 4 wherein said upper area is larger in diameter than said lower area.

6. A dental device as in claim 1 wherein a second tip is secured to said second end.

7. A dental device as in claim 2 wherein a second tip is secured to said second end and said second tip is removably secured to said second end.

8. A dental device as in claim 1 wherein said lower portion includes a flat golf head shaped segment.

9. A dental device as in claim 8 wherein said second end includes a second tip having an upper portion and a lower portion, said upper portion of said second tip is secured to said lower portion of said second tip at an universal angle and said second tip is fabricated from titanium nitride or is coated with titanium nitride.

10. A dental device as in claim 9 wherein said first tip and said second tip are each removably secured to said shank.

11. A dental device as in claim 9 wherein each lower portion of said first tip and said second tip includes a flat golf head shaped segment.

12. A dental device as in claim 11 wherein said tip of said first end is secured to said shank so that it extends upwardly with respect to the horizontal of said shank and said second tip is secured to said shank so that it extends downwardly with respect to the horizontal of said shank and with respect to said tip of said first end.

13. A dental device as in claim 12 wherein said tip of said first end is secured perpendicularly to said first portion of said tip with respect to the horizontal of said shank so that said flat golf head shaped segment is visible and said second tip is rotated 90 degrees and is perpendicularly secured to said first portion of second end with respect to the horizontal of said shank so that an edge of said flat golf head shaped segment is visible.

14. A dental device as in claim 1 wherein said shank includes a roughen surface.

15. A dental device as in claim 1 wherein said shank includes indentations for receiving a thumb and a finger of a user.

16. A method of dental restorations comprising:
(a) determining if location of dental restoration is located on a pulpal floor of smaller cavities or larger cavities or on an axial wall;
(b) a set of tools including a first tool having a first tip, said first tip is flat and includes a substantially small surface area is used for smaller cavities restoration, a second tool having a second tip, said second tip includes a first portion and a second portion, said first portion includes a groove and is used for larger cavities restoration, and a third tool having a third tip with substantially a flat golf club configuration and is used on axial wall restoration;
(c) Selecting a tool from said set of tools having a tip appropriate for a particular restoration; and
(d) Said tip of each tool being fabricated from titanium nitride or is coated with titanium nitride.

17. A method of dental restorations comprising:
(a) determining if location of dental restoration is located on a pulpal floor of smaller cavities or larger cavities or on an axial wall;
(b) a shank having a first end and a second end, said first end includes an attaching device for enabling a plurality of tips to be removably secured to said shank;
(c) said plurality of tips include a first tip, said first tip is flat and includes a substantially small surface area is used for smaller cavities restoration, a second tip, said second tip includes a first portion and a second portion, said first portion includes a groove and is used for larger cavities restoration, and a third tip with substantially a flat golf club configuration and is used on axial wall restoration;
(d) each tip includes a first portion and a second portion, said first portion includes an attaching device corresponding to said attaching device of said first end of said shank;
(e) Selecting a tip from said plurality of tips wherein said tip is appropriate for a particular restoration;
(f) Securing a selected tip from said plurality of tips to said shank via said attaching devices and proceeding with restoration.

18. A method as in claim 17 further comprising:
(g) Each tip of said plurality of tips being fabricated from titanium nitride or is coated with titanium nitride.
